(19) United States
(12) Patent Application Publication
(10) Pub. No.: US 2017/0046093 A1
(43) Pub. Date: Feb. 16, 2017

(54) BACKUP STORAGE

(71) Applicant: HEWLETT PACKARD ENTERPRISE DEVELOPMENT LP, Houston, TX (US)

(72) Inventor: John Butt, Bristol (GB)

(21) Appl. No.: 15/305,452

(22) PCT Filed: May 29, 2014
(86) PCT No.: PCT/US2014/039903

§ 371 Date: Oct. 20, 2016

(51) Int. Cl. G06F 3/06

(52) U.S. Cl. CPC G06F 3/0641; G06F 3/0608; G06F 3/0619; G06F 3/0652; G06F 3/0673

(57) ABSTRACT

Determination may be made, for a first backup file comprising deduplication data in a first backup storage device, whether the first backup file comprises a number of tags ready for deletion higher than a threshold amount. Responsive to determining that the number of tags ready for deletion is higher than the threshold amount, each corresponding set of data associated with a tag ready for deletion in the first backup file may be deleted.

### BACKGROUND

Computing systems that handle data may back up that data to backup data storage devices. Backup storage devices may engage in data deduplication when storing data from a computing system. As such, backup storage devices may reduce the number of duplicate copies of a set of data stored in the backup storage device.

### BRIEF DESCRIPTION OF THE DRAWINGS

The following detailed description references the drawings, wherein:

FIG. 1 is a block diagram of an example backup storage device;

FIG. 2 is a flowchart of an example method for execution by a backup storage device;

FIG. 3 is a flowchart of an example method for execution by a backup storage device;

FIG. 4 is a flowchart of an example method for execution by a backup storage device;

FIG. 5 is a block diagram of an example backup storage device;

FIG. 6 is a block diagram of an example backup storage device; and

FIG. 7 is a block diagram of an example backup storage device.

### DETAILED DESCRIPTION

A backup storage device may backup data from one or more computing systems as deduplicated data. As data in the backup storage device is deleted, files storing deduplicated data may become fragmented. Determining, for each file in a backup storage device, which data to delete and subsequently deleting that data may require a lot of processing power and may affect system performance of the backup storage device. The throughput for the backup storage device may be negatively affected as well due to the backup storage device performing a costly deletion of data in each of its files. Further, backup storage systems may not have efficient mechanisms for deleting data that should not have been backed up (e.g., confidential data that was accidentally or mistakenly backed up to the backup storage device).

In some examples of the present techniques, a backup storage device may manage deduplicated data for efficient and secure deletion of data from the backup storage device. The backup storage device may determine whether to delete data from a backup file based on whether the file comprises enough data that is ready for deletion. For example, the backup storage device may determine a number of chunks of data or references to data chunks in the file associated with tags that are ready for deletion. Responsive to a number of tags ready for deletion exceeding a threshold amount, the backup storage device may delete the chunks of data or references associated with those tags. Responsive to a number of tags not exceeding the threshold, the backup storage device may check another file to determine whether the file is ready for deletion. As such, the backup storage device may only delete data from a file responsive to a critical mass of data being ready for deletion. Accordingly, the throughput and i/o workload of the backup storage device may be reduced by selectively deleting deduplication data from backup files.

The backup storage device may also delete all chunks of data or references to chunks of data in each file in a backup storage device responsive to the backup storage device being in a secure mode.

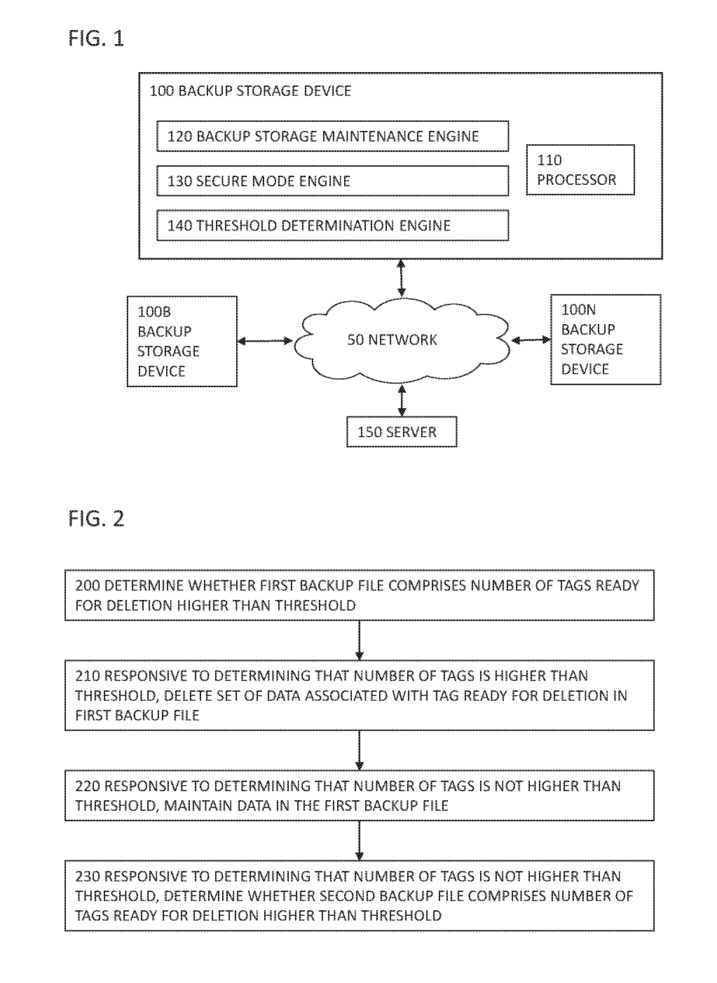

Referring now to the drawings, FIG. 1 is a block diagram of an example backup storage device 100. Backup storage device 100 may comprise storage media for storing deduplication data such as, for example, one or more arrays of magnetic disk drives, solid state drives, optical, magneto-optical, or electro-optical storage media, storage media configured to implement RAID (redundant array of independent disks) redundancy, cloud-based storage, storage media capable of handling big data, and/or other types of storage suitable for executing the functionality described below. In the example depicted in FIG. 1, backup storage device 100 includes a non-transitory machine-readable storage medium and a processor 110. In the example depicted in FIG. 1, the backup storage device 100 may be part of a system of backup storage devices 100, 100B, . . . , 100N that may be communicably coupled via a network 50. The network 50 may be any wired, wireless and/or other type of network via which the backup storage devices 100, 100B, . . . , 100N may communicate. The system may also comprise a server 150 via which the deduplication data stored in the backup storage devices 100, 100B, . . . , 100N may be viewed, accessed, deleted, and/or otherwise managed by a user.

Each of the backup storage devices 100, 100B, . . . , 100N may store deduplication data received from other computing systems. In some examples, each of the backup storage devices 100, 100B, . . . , 100N may store disparate deduplication data, such that the deduplication data stored at backup storage device 100 may correspond to a first set of data backed up from a computing system that is different from a second set of data backed up from the computing system that may be stored as deduplication data at backup storage device 100N. In some examples, each of the backup storage devices 100, 100B, . . . , 100N may comprise the same or similar functionality.

Processor 110 may be one or more central processing units (CPUs), microprocessors, and/or other hardware devices suitable for retrieval and execution of instructions stored in machine-readable storage medium. Processor 110 may fetch, decode, and execute program instructions to manage deduplication data, as described below. As an alternative or in addition to retrieving and executing instructions, processor 110 may include one or more electronic circuits comprising a number of electronic components for performing the functionality of one or more of instructions.

In one example, the program instructions can be part of an installation package that can be executed by processor 110 to implement the functionality described herein. In this case, machine-readable storage medium may be a portable medium such as a CD, DVD, or flash drive or a memory maintained by a backup storage device from which the installation package can be downloaded and installed. In another example, the program instructions may be part of an application or applications already installed on backup storage device 100.

Machine-readable storage medium may be any hardware storage device for maintaining data accessible to backup storage device 100. For example, machine-readable storage medium may include one or more hard disk drives, solid state drives, tape drives, and/or any other storage devices. The storage devices may be located in backup storage device 100 and/or in another device in communication with backup storage device 100. For example, machine-readable storage medium may be any electronic, magnetic, optical, or other physical storage device that stores executable instructions. Thus, machine-readable storage medium may be, for example, Random Access Memory (RAM), an Electrically-Erasable Programmable Read-Only Memory (EEPROM), a storage drive, an optical disc, and the like. As described in detail below, machine-readable storage medium may be encoded with executable instructions for managing deduplication data of a backup storage device. As detailed below, storage medium may maintain and/or store the data and information described herein.

As discussed further below, the backup storage device 100 may manage deduplication data to ensure efficient deletion of unnecessary deduplication data as well as secure deletion of deduplication data.

As detailed below, backup storage device 100 may include a series of engines 130-140 for managing deduplication data. Each of the engines may generally represent any combination of hardware and programming. For example, the programming for the engines may be processor executable instructions stored on a non-transitory machine-readable storage medium and the hardware for the engines may include at least one processor of the backup storage device 100 to execute those instructions. In addition or as an alternative, each engine may include one or more hardware devices including electronic circuitry for implementing the functionality described below.

Backup storage maintenance engine 120 may manage the deduplication data in the backup storage device 100. For example, backup storage maintenance engine 130 may add new data to the backup storage device 100, delete existing data in the backup storage device 100, manage tags associated with data stored in the backup storage device 100, and/or otherwise manage the backup storage device 100. Backup storage maintenance engine 120 may comprise other functionality related to managing the backup storage device 100 and is not limited to the examples described herein.

In some examples, backup storage maintenance engine 120 may receive a new set of data from a computing system. The new set of data may comprise multiple sequential chunks of data. An individual chunk of data may comprise, for example, 4 KB of data, 8 KB of data, and/or another amount of data, such that the size of a data chunk is consistent throughout the backup storage device 100.

Backup storage maintenance engine 120 may back up the new set of data by determining whether any of the chunks of data in the new set of data are already stored in the backup storage device 100. For example, for a first chunk of data of the new set of data, the backup storage maintenance engine 120 may determine whether data identical to that first chunk is already stored in the storage device 100. The backup storage maintenance engine 120 may determine whether a first backup file comprises a stored chunk identical to the first chunk of the new data set. Responsive to the first backup file not comprising a stored chunk identical to the first chunk, the backup storage maintenance engine 120 may determine whether a second backup file comprises an identical stored chunk. Responsive to the backup storage device 100 not comprising a stored chunk identical to the first chunk, the backup storage maintenance engine 120 may maintain the first chunk in the new set of data and may associate a new tag with the first chunk. The new tag may comprise a counter with a value of zero, where the tag may be incremented or decremented by the backup storage maintenance engine 120.

Responsive to the first backup file comprising a stored chunk of data identical to the first chunk of data from the new set of data to be backed up, the backup storage maintenance engine 120 may replace the first chunk in the new set of data with a reference to the stored chunk and with an associated tag. The associated tag may comprise a counter which may be incremented or decremented by the backup storage maintenance engine 120. The backup storage maintenance engine 120 may increment a tag associated with the stored chunk of data by a predetermined amount and may increment the associated tag by the predetermined amount. In some examples, the backup storage maintenance engine 120 may also determine whether any other references to the stored chunk exist in the backup storage device 100 and may increment the tags associated with those other references by the predetermined amount.

Responsive to each chunk in the new set of data being handled by the backup storage maintenance engine 120 in a manner the same as or similar to the first chunk of the new set of data, the potentially revised new set of data may be stored in the storage medium of the backup storage device 100 as backed up new set of data. The backed up new set of data may comprise one or more chunks of data and one or more references to stored chunks of data, where each chunk of data and each reference has a corresponding tag.

In some examples, the backup storage maintenance engine 120 may determine whether other backup storage devices (e.g., devices 100B, . . . , 100N) that are communicably coupled to backup storage device 100 comprise data identical to the first chunk of data as well. In other examples, the backup storage maintenance engine 120 may only check the data stored at the individual backup storage device 100.

In some examples, the backup storage maintenance engine 120 may delete existing data in the backup storage device 100. The backup storage maintenance engine 120 may determine whether to delete existing data in the backup storage device 100 at predetermined time intervals, responsive to the available storage of the backup storage device 100 being below a predetermined threshold amount, at random time intervals, responsive to user interaction, a predetermined amount of time after the backup storage device 100 was in secure mode, based on feedback from the storage medium to monitor free space, based on other conditions being met, and/or based on other factors. The backup storage maintenance engine may also delete data in the backup storage device 100 responsive to the backup storage device 100 entering a secure mode (as discussed further below).

While the backup storage device 100 is not in a secure mode, the backup storage maintenance engine 120 may delete existing data in a backup storage file responsive to certain conditions being met. For example, responsive to a number of tags associated with either chunks of data or references in a data file being ready for deletion, the backup storage maintenance engine 120 may delete data in the backup data file. A tag ready for deletion may comprise a tag with a counter of zero (and/or other predetermined amount that indicates the tag is ready for deletion).

Responsive to the backup storage maintenance engine 120 determining to delete existing data in the backup storage device 100 (and the backup storage device 100 not being in a secure mode), the backup storage maintenance engine 120 may determine, for a first backup file in the backup storage device 100, whether the first backup file comprises a number of tags ready for deletion higher than a threshold amount. For example, the backup storage maintenance engine 120 may determine a number of tags associated with either chunks of data or references in the first backup file with a counter of zero (or other predetermined amount that indicates the tag is ready for deletion).

Responsive to determining that the number of tags ready for deletion is higher than the threshold amount, the first backup file comprises a number of tags ready for deletion higher than a threshold amount may delete each corresponding chunk of data or reference associated with a tag ready for deletion in the first backup file. As discussed further below, the threshold amount may be preset, may be determined by an administrator and/or other user of the system, and/or may be determined based on certain conditions.

For each chunk of data or reference deleted, the backup storage maintenance engine 120 may determine whether other references to that chunk of data or reference exist in the backup storage device 100. For each other reference that exists, the backup storage maintenance engine 120 may decrement the tag associated with that other reference.

Responsive to determining that the number of tags ready for deletion is not higher than the threshold amount, the backup storage maintenance engine 120 may maintain the data in the first backup file and may determine whether a second backup file in the data storage comprises a number of tags ready for deletion higher than the threshold amount. The backup storage maintenance engine 120 may determine whether each file in the backup storage device 100 is ready for deletion and may delete or maintain the data in each file accordingly.

Secure mode engine 130 may manage the backup storage device 100 in a secure mode. For example, secure mode engine 130 may manage entry of the backup storage device 100 in a secure mode, deletion of data during a secure mode, and/or other functionality that may be performed during secure mode for the backup storage device 100. Secure mode engine 130 may comprise other functionality related to managing the backup storage device 100 during secure mode and is not limited to the examples described herein.

Secure mode engine 130 may determine whether the backup storage device 100 has entered a secure mode. Responsive to determining that the backup storage device 100 has entered a secure mode, the secure mode engine 130 may delete each chunk of data or reference that is associated with a tag ready for deletion in each backup file in the backup storage device 100. The secure mode engine 130 may delete data in each file regardless of a number of tags ready for deletion in that file. For each chunk of data or reference deleted, the secure mode engine 130 may determine whether other references to that chunk of data or reference exist in the backup storage device 100. For each other reference that exists, the secure mode engine 130 may decrement the tag associated with that other reference.

In some examples, multiple types of secure mode may exist. In some examples, the example functionality performed by secure mode engine 130 may be the same or similar in each type of secure mode.

Threshold determination engine 140 may manage the threshold based on which data in a backup file may be deleted. In some examples, a threshold may be pre-set, may be provided by an administrator, and/or other user of the backup storage device, and/or may be otherwise determined. The threshold may be fixed, or may be dynamic based on various conditions of the backup storage device.

In some examples, the threshold determination engine 140 may revise the threshold based on various conditions of the backup storage device. For example, the threshold determination engine 140 may determine a revised threshold based on throughput of the backup storage device 100, based on an amount of free space in the backup storage device 100, a number of concurrent connections to the backup storage device 100, an i/o workload on the backup storage device 100, processor usage of the backup storage device 100, an amount of time after being in secure mode, feedback from the storage medium to monitor free space, and/or other factors that may affect the rate at which data should be deleted from the backup storage device 100.

FIG. 2 is a flowchart of an example method for execution by a backup storage device.

Although execution of the method described below is with reference to backup storage device 100 of FIG. 1, other suitable devices for execution of this method will be apparent to those of skill in the art (e.g., backup storage device 100B of FIG. 1, and/or other backup storage devices). The method described in FIG. 2 and other figures may be implemented in the form of executable instructions stored on a machine-readable storage medium of backup storage device 100, by one or more engines described herein, and/or in the form of electronic circuitry.

In an operation at block 200, a determination may be made as to whether a first backup file in a backup storage device comprises a number of tags ready for deletion higher than a predetermined threshold. For example, the backup storage device 100 (and/or the backup storage maintenance engine 120, or other resource of the backup storage device 100) may determine whether the number of tags is higher than the threshold. The backup storage device 100 may determine whether the number of tags is higher than the threshold in a manner similar or the same as that described above in relation to the execution of the backup storage maintenance engine 120, and/or other resource of the backup storage device 100.

In an operation at block 210, a set of data associated with a tag ready for deletion is deleted from the first backup file responsive to determining that the number of tags ready for deletion is higher than the predetermined threshold. For example, the backup storage device 100 (and/or the backup storage maintenance engine 120, or other resource of the backup storage device 100) may delete the set of data. The backup storage device 100 may delete the set of data in a manner similar or the same as that described above in relation to the execution of the backup storage maintenance engine 120, and/or other resource of the backup storage device 100.

In an operation at block 220, data in the first backup file may be maintained responsive to determining that the number of tags ready for deletion is not higher than the predetermined threshold. For example, the backup storage device 100 (and/or the backup storage maintenance engine 120, or other resource of the backup storage device 100) may maintain the data in the first backup file. The backup storage device 100 may maintain the data in the first backup file in a manner similar or the same as that described above in relation to the execution of the backup storage maintenance engine 120, and/or other resource of the backup storage device 100.

In an operation at block 230, a determination may be made as to whether a second backup file in a backup storage device comprises a number of tags ready for deletion higher than a predetermined threshold responsive to determining that the number of tags ready for deletion in the first backup file is not higher than the predetermined threshold. For example, the backup storage device 100 (and/or the backup storage maintenance engine 120, or other resource of the backup storage device 100) may determine whether the number of tags in the second backup file is higher than the threshold. The backup storage device 100 determine whether the number of tags in the second backup file is higher than the threshold in a manner similar or the same as that described above in relation to the execution of the backup storage maintenance engine 120, and/or other resource of the backup storage device 100.

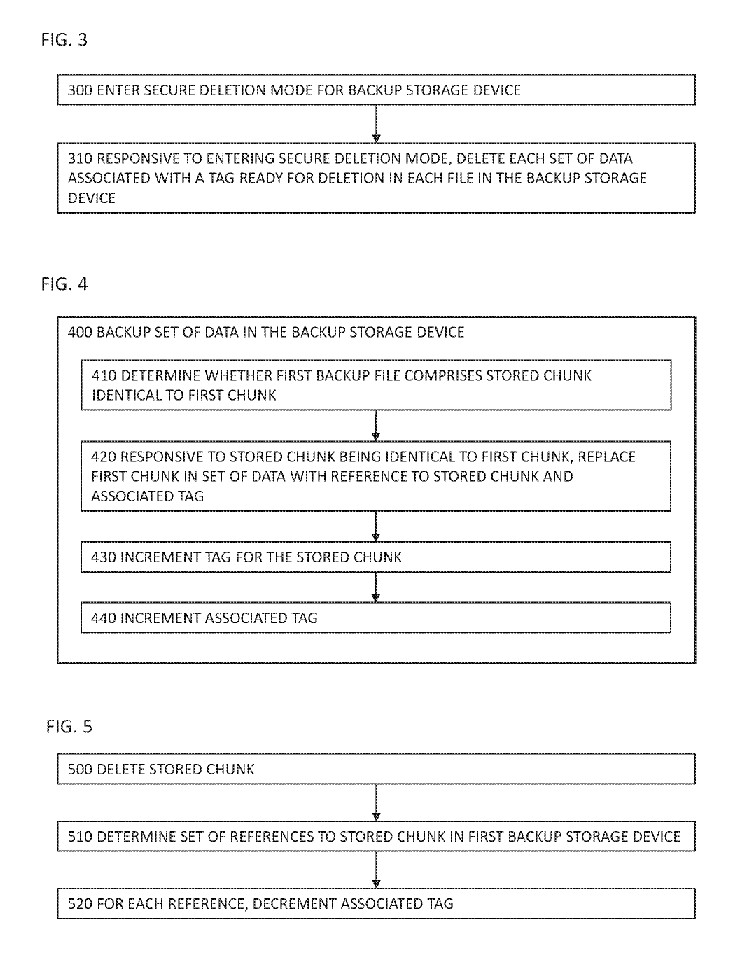

FIG. 3 is a flowchart of an example method for execution by a backup storage device.

In an operation at block 300, the backup storage device may enter a secure deletion mode. For example, the backup storage device 100 (and/or the secure mode engine 130, or other resource of the backup storage device 100) may enter secure deletion mode. The backup storage device 100 may enter secure deletion mode in a manner similar or the same as that described above in relation to the execution of the secure mode engine 130, and/or other resource of the backup storage device 100.

In an operation at block 310, each set of data associated with a tag ready for deletion in each file of the backup storage device may be deleted responsive to the backup storage device entering secure deletion mode. For example, the backup storage device 100 (and/or the secure mode engine 130, or other resource of the backup storage device 100) may delete each set of data. The backup storage device 100 may delete each set of data in a manner similar or the same as that described above in relation to the execution of the secure mode engine 130, and/or other resource of the backup storage device 100.

FIG. 4 is a flowchart of an example method for execution by a backup storage device.

In an operation at block 400, a new set of data may be backed up in the storage device. For example, the backup storage device 100 (and/or the backup storage maintenance engine 120, or other resource of the backup storage device 100) may back up the new set of data. The backup storage device 100 may backup the new set of data in a manner similar or the same as that described above in relation to the execution of the backup storage maintenance engine 120, and/or other resource of the backup storage device 100.

In some examples, operations at blocks 410-440 may comprise sub-operations via which operation at block 400 may be performed. In an operation at block 410, a determination may be made as to whether a first backup file of the backup storage device comprises a stored chunk that is identical to a first chunk of the new set of data. For example, the backup storage device 100 (and/or the backup storage maintenance engine 120, or other resource of the backup storage device 100) may determine whether the first chunk is identical to the stored chunk. The backup storage device 100 may determine whether the first chunk is identical to the stored chunk in a manner similar or the same as that described above in relation to the execution of the backup storage maintenance engine 120, and/or other resource of the backup storage device 100.

In an operation at block 420, the first chunk in the new set of data may be replaced with a reference to the stored chunk and an associated tag responsive to the first chunk being identical to the stored chunk. For example, the backup storage device 100 (and/or the backup storage maintenance engine 120, or other resource of the backup storage device 100) may replace the first chunk. The backup storage device 100 may replace the first chunk in a manner similar or the same as that described above in relation to the execution of the backup storage maintenance engine 120, and/or other resource of the backup storage device 100.

In an operation at block 430, a tag associated with the stored chunk may be incremented. For example, the backup storage device 100 (and/or the backup storage maintenance engine 120, or other resource of the backup storage device 100) may increment the tag associated with the stored chunk. The backup storage device 100 may increment the tag associated with the stored chunk in a manner similar or the same as that described above in relation to the execution of the backup storage maintenance engine 120, and/or other resource of the backup storage device 100.

In an operation at block 440, the associated tag may be incremented. For example, the backup storage device 100 (and/or the backup storage maintenance engine 120, or other resource of the backup storage device 100) may increment the associated tag. The backup storage device 100 may increment the associated tag in a manner similar or the same as that described above in relation to the execution of the backup storage maintenance engine 120, and/or other resource of the backup storage device 100.

FIG. 5 is a flowchart of an example method for execution by a backup storage device.

In an operation at block 500, a stored chunk may be deleted. For example, the backup storage device 100 (and/or the backup storage maintenance engine 120, or other resource of the backup storage device 100) may delete the stored chunk. The backup storage device 100 may delete the stored chunk in a manner similar or the same as that described above in relation to the execution of the backup storage maintenance engine 120, and/or other resource of the backup storage device 100.

In an operation at block 510, a set of references to the stored chunk in the backup storage device may be determined. For example, the backup storage device 100 (and/or the backup storage maintenance engine 120, or other resource of the backup storage device 100) may determine the set of references. The backup storage device 100 may determine the set of references in a manner similar or the same as that described above in relation to the execution of the backup storage maintenance engine 120, and/or other resource of the backup storage device 100.

In an operation at block 520, for each reference in the determined set of references, the associated tag is decremented. For example, the backup storage device 100 (and/or the backup storage maintenance engine 120, or other resource of the backup storage device 100) may decrement the associated tag. The backup storage device 100 may decrement the associated tag in a manner similar or the same as that described above in relation to the execution of the backup storage maintenance engine 120, and/or other resource of the backup storage device 100.

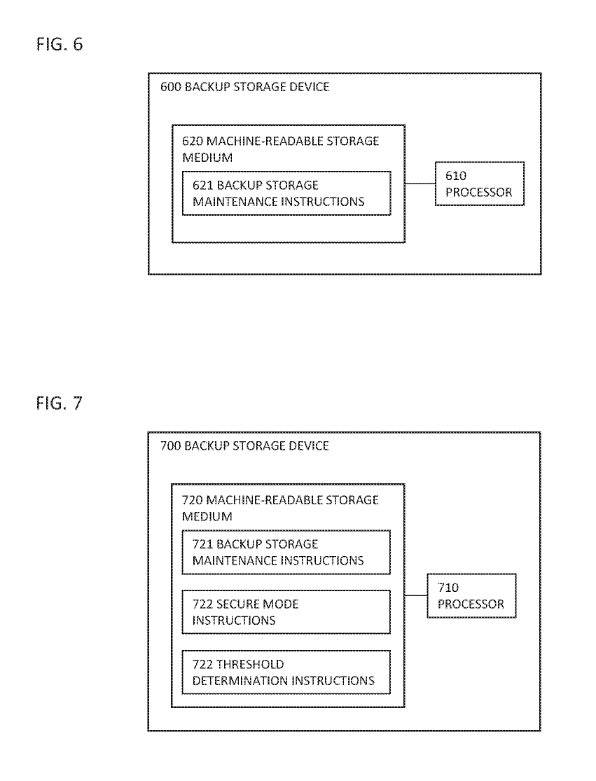

FIG. 6 is a block diagram of an example backup storage device 600. Backup storage device 600 may comprise storage media for storing deduplication data such as, for example, one or more arrays of magnetic disk drives, solid state drives, optical, magneto-optical, or electro-optical storage media, storage media configured to implement RAID redundancy, cloud-based storage, storage media capable of handling big data, and/or other types of storage suitable for executing the functionality described below. In the example depicted in FIG. 6, backup storage device 600 includes a non-transitory machine-readable storage medium 620 and a processor 610.

Processor 610 may be one or more central processing units (CPUs), microprocessors, and/or other hardware devices suitable for retrieval and execution of instructions stored in machine-readable storage medium 620.

Processor 610 may fetch, decode, and execute program instructions 621, and/or other instructions to enable managing deduplication data, as described below. As an alternative or in addition to retrieving and executing instructions, processor 610 may include one or more electronic circuits comprising a number of electronic components for performing the functionality of one or more of program instructions 621, and/or other instructions.

In one example, the program instructions can be part of an installation package that can be executed by processor 610 to implement the functionality described herein. In this case, machine-readable storage medium 620 may be a portable medium such as a CD, DVD, or flash drive or a memory maintained by another backup storage device from which the installation package can be downloaded and installed. In another example, the program instructions may be part of an application or applications already installed on backup storage device 600.

Machine-readable storage medium 620 may be any hardware storage device for maintaining data accessible to backup storage device 600. For example, machine-readable storage medium 620 may include one or more hard disk drives, solid state drives, tape drives, and/or any other storage devices. The storage devices may be located in backup storage device 600 and/or in another device in communication with backup storage device 600. For example, machine-readable storage medium 620 may be any electronic, magnetic, optical, or other physical storage device that stores executable instructions. Thus, machine-readable storage medium 620 may be, for example, Random Access Memory (RAM), an Electrically-Erasable Programmable Read-Only Memory (EEPROM), a storage drive, an optical disc, and the like. As detailed below, storage medium 620 may maintain and/or store the data and information described herein.

Machine-readable storage medium 620 may also be encoded with executable instructions for enabling execution of the functionality described herein. For example, machine-readable storage medium 620 may store backup storage maintenance instructions 621, and/or other instructions that may be used to carry out the functionality of the herein disclosed present techniques.

Backup storage maintenance instructions 621, when executed by processor 610, may determine, for a first backup file comprising deduplication data in the backup storage device 600, whether the first backup file comprises a number of tags ready for deletion higher than a predetermined threshold amount. The backup storage maintenance instructions 621, when executed by processor 610, may delete each corresponding set of data associated with a tag ready for deletion in the first backup file responsive to determining that the number of tags ready for deletion is higher than the predetermined threshold amount. In some examples, the functionality performed by the backup storage maintenance instructions 621, when executed by processor 610, may be the same as or similar to functionality performed by backup storage maintenance engine 120 of backup storage device 100.

FIG. 7 is a block diagram of an example backup storage device 700. Backup storage device 700 may comprise storage media for storing deduplication data such as, for example, one or more arrays of magnetic disk drives, solid state drives, optical, magneto-optical, or electro-optical storage media, storage media configured to implement RAID redundancy, cloud-based storage, storage media capable of handling big data, and/or other types of storage suitable for executing the functionality described below. In the example depicted in FIG. 7, backup storage device 700 includes a non-transitory machine-readable storage medium 720 and a processor 710.

Processor 710 may be one or more central processing units (CPUs), microprocessors, and/or other hardware devices suitable for retrieval and execution of instructions stored in machine-readable storage medium 720.

Processor 710 may fetch, decode, and execute program instructions 721, 722, 723, and/or other instructions to manage deduplication data, as described below. As an alternative or in addition to retrieving and executing instructions, processor 710 may include one or more electronic circuits comprising a number of electronic components for performing the functionality of one or more of program instructions 721, 722, 723, and/or other instructions.

In one example, the program instructions can be part of an installation package that can be executed by processor 710 to implement the functionality described herein. In this case, machine-readable storage medium 720 may be a portable medium such as a CD, DVD, or flash drive or a memory maintained by another backup storage device from which the installation package can be downloaded and installed. In another example, the program instructions may be part of an application or applications already installed on backup storage device 700.

Machine-readable storage medium 720 may be any hardware storage device for maintaining data accessible to backup storage device 700. For example, machine-readable storage medium 720 may include one or more hard disk drives, solid state drives, tape drives, and/or any other storage devices. The storage devices may be located in backup storage device 700 and/or in another device in communication with backup storage device 700. For example, machine-readable storage medium 720 may be any electronic, magnetic, optical, or other physical storage device that stores executable instructions. Thus, machine-readable storage medium 720 may be, for example, Random Access Memory (RAM), an Electrically-Erasable Programmable Read-Only Memory (EEPROM), a storage drive, an optical disc, and the like. As detailed below, storage medium 720 may maintain and/or store the data and information described herein.

Machine-readable storage medium 720 may also be encoded with executable instructions for enabling execution of the functionality described herein. For example, machine-readable storage medium 720 may store program instructions 721, 722, 723, and/or other instructions that may be used to carry out the functionality of the herein disclosed present techniques.

Backup storage maintenance instructions 721, when executed by processor 710, may determine, for a first backup file comprising deduplication data in the backup storage device 600, whether the first backup file comprises a number of tags ready for deletion higher than a predetermined threshold amount. The backup storage maintenance instructions 721, when executed by processor 710, may delete each corresponding set of data associated with a tag ready for deletion in the first backup file responsive to determining that the number of tags ready for deletion is higher than the predetermined threshold amount. In some examples, the functionality performed by the backup storage maintenance instructions 721, when executed by processor 710, may be the same as or similar to functionality performed by backup storage maintenance engine 120 of backup storage device 100.

Secure mode instructions 722, when executed by processor 710, may enter a secure deletion mode for the backup storage device 700. In some examples, the secure mode instructions 722, when executed by processor 710, may delete each set of data associated with a tag ready for deletion in each file in the backup storage device 700 responsive to the backup storage device 700 entering secure deletion mode. In some examples, the functionality performed by the secure mode instructions 722, when executed by processor 710, may be the same as or similar to functionality performed by secure mode engine 130 of backup storage device 100.

Threshold determination instructions 723, when executed by processor 710, may determine the threshold against which the number of tags ready for deletion are compared. In some examples, the threshold determination instructions 723, when executed by processor 710, may determine the threshold based on throughput of the backup storage device 700, amount of available space in the backup storage device, and/or based on other constraints. In some examples, the functionality performed by the threshold determination instructions 723, when executed by processor 710, may be the same as or similar to functionality performed by threshold determination engine 140 of backup storage device 100.

The foregoing disclosure describes a number of examples for managing a backup storage device. The disclosed examples may include systems, devices, computer-readable storage media, and methods for managing a backup storage device. For purposes of explanation, certain examples are described with reference to the components illustrated in FIGS. 1-7. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Further, the sequence of operations described in connection with FIGS. 1-7 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

We claim:

1. A backup storage device comprising:
a backup storage maintenance engine to:
determine, for a first backup file comprising deduplication data in a first backup storage device, whether the first backup file comprises a number of tags ready for deletion higher than a threshold amount; and
responsive to determining that the number of tags ready for deletion is higher than the threshold amount, delete each corresponding set of data associated with a tag ready for deletion in the first backup file; and
a secure mode engine to:
determine whether the first backup storage device entered a secure deletion mode; and
delete each set of data associated with a tag ready for deletion in each file in the backup storage device regardless of a number of tags ready for deletion in each file, responsive to determining that the first backup storage device entered the secure deletion mode.

2. The backup storage device of claim 1, wherein the backup storage maintenance engine:
determines, responsive to determining that the number of tags ready for deletion is not higher than the threshold amount, whether a second backup file comprising deduplication data in the first backup storage device comprises a second number of tags ready for deletion higher than the threshold amount.

3. The backup storage device of claim 1, wherein the corresponding set of data comprises one of: a chunk of data stored in the first backup file or a reference to a stored chunk of data stored in a separate backup file, and
wherein the backup storage maintenance engine backs up a new set of data comprising a first chunk to the first backup storage device by:
determining whether the first backup file comprises a stored chunk identical to the first chunk;
responsive to the stored chunk being identical to the first chunk, replacing the first chunk in the new set of data with a reference to the stored chunk and an associated tag;
incrementing a tag for the stored chunk by a predetermined amount; and
incrementing the associated tag by the predetermined amount.

4. The system of claim 3, wherein the backup storage maintenance engine:
deletes the stored chunk;
determines a set of references to the stored chunk in the first backup storage device; and
for each reference of the set of references, decrements an associated tag by the predetermined amount, wherein an associated tag with a count of zero is ready for deletion.

5. A method for execution by a backup storage device, the method comprising:
determining, for a first backup file comprising deduplication data in a first backup storage device, whether the first backup file comprises a number of tags ready for deletion higher than a threshold amount;
responsive to determining that the number of tags ready for deletion is higher than the threshold amount, deleting each corresponding set of data associated with a tag ready for deletion in the first backup file; and
responsive to determining that the number of tags ready for deletion is not higher than the threshold amount:
maintaining the data in the first backup file; and
determining, for a second backup file comprising deduplication data in the first backup storage device, whether the second backup file comprises a second number of tags ready for deletion higher than the threshold amount.

6. The method of claim 5, further comprising:
entering a secure deletion mode for the first backup storage device; and
responsive to entering the secure deletion mode, deleting each set of data associated with a tag ready for deletion in each file in the backup storage device regardless of a number of tags ready for deletion in each file.

7. The method of claim 5, wherein the corresponding set of data comprises one of: a chunk of data stored in the first backup file or a reference to a stored chunk of data stored in a separate backup file, and
wherein the method further comprises: backing up a new set of data comprising a first chunk to the first backup storage device by:
determining whether the first backup file comprises a stored chunk identical to the first chunk;
responsive to the stored chunk being identical to the first chunk, replacing the first chunk in the new set of data with a reference to the stored chunk and an associated tag;
incrementing a tag for the stored chunk by the predetermined amount; and
incrementing the associated tag by the predetermined amount.

8. The method of claim 7, further comprising:
deleting the stored chunk;
determining a set of references to the stored chunk in the first backup storage device; and
for each reference of the set of references, decrementing an associated tag by the predetermined amount, wherein an associated tag with a count of zero is ready for deletion.

9. A non-transitory machine-readable storage medium comprising instructions executable by a processor of a backup storage device to:
determine, for a first backup file comprising deduplication data in a first backup storage device, whether the first backup file comprises a number of tags ready for deletion higher than a threshold amount; and
responsive to determining that the number of tags ready for deletion is higher than the threshold amount, delete each corresponding set of data associated with a tag ready for deletion in the first backup file.

10. The storage medium of claim 9, further comprising instructions executable by the processor of the backup storage device to:
responsive to determining that the number of tags ready for deletion is not higher than the threshold amount, determine, for a second backup file comprising deduplication data in the first backup storage device, whether the second backup file comprises a second number of tags ready for deletion higher than the threshold amount.

11. The storage medium of claim 9, further comprising instructions executable by the processor of the backup storage device to:
enter a secure deletion mode for the first backup storage device; and
responsive to entering the secure deletion mode, delete each set of data associated with a tag ready for deletion in each file in the backup storage device regardless of a number of tags ready for deletion in each file.

12. The storage medium of claim 9, wherein the corresponding set of data comprises one of: a chunk of data stored in the first backup file or a reference to a stored chunk of data stored in a separate backup file.

13. The storage medium of claim 12, further comprising instructions executable by the processor of the backup storage device to:
back up a new set of data comprising a first chunk to the first backup storage device by:
determining whether the first backup file comprises a stored chunk identical to the first chunk;
responsive to the stored chunk being identical to the first chunk, replacing the first chunk in the new set of data with a reference to the stored chunk and an associated tag;
incrementing a tag for the stored chunk by a predetermined amount; and
incrementing the associated tag by the predetermined amount.

14. The storage medium of claim 13, further comprising instructions executable by the processor of the backup storage device to:
delete the stored chunk;
determine a set of references to the stored chunk in the first backup storage device; and
for each reference of the set of references, decrement an associated tag by the predetermined amount, wherein an associated tag with a count of zero is ready for deletion.

15. The storage medium of claim 9, further comprising instructions executable by the processor of the backup storage device to:
determine the threshold based on throughput of the first backup storage device and amount of free space in the first backup storage device.
